(19) United States
(12) Patent Application Publication
(10) Pub. No.: US 2013/0311326 A1
(43) Pub. Date: Nov. 21, 2013

(54) VIRTUAL REGISTRY

(71) Applicants: JENNIFER M. LUCAS, Charlotte, NC (US); JASON PHILIP TYPRIN, Charlotte, NC (US)

(72) Inventors: JENNIFER M. LUCAS, Charlotte, NC (US); JASON PHILIP TYPRIN, Charlotte, NC (US)

(73) Assignee: BANK OF AMERICA CORPORATION, Charlotte, NC (US)

(21) Appl. No.: 13/472,771

(22) Filed: May 16, 2012

(51) Int. Cl. G06Q 30/06

(52) U.S. Cl. 705/26.8

(57) ABSTRACT

Embodiments of the invention provide for a virtual registry system that automatically attaches gift credit to a registry account of the gift recipient. The virtual registry system allows users to give gifts for specific purposes using aliases that eliminate the need for sharing of confidential, personal, or secure information. The use of aliases, which serve to tie an identifier, such as an event title, telephone number, or the like to a registry account, embodiments of the invention do not require that the gift provider know any information about the financial accounts of the intended gift recipient. By attaching the gift credit amount to the registry account, subsequent purchases made using the registry account, and of the type associated with the gift credit, (e.g., purchases for a specific item on the registry) are automatically settled by applying the gift credit amount to the purchase amount.

### BACKGROUND

Most merchants have traditional or online gift registries that require gift recipients to disclose confidential or personal information, such as financial account information, personal names, dates, locations, or other information that the user may prefer to keep private. Similarly, gift providers must know the confidential information of the gift recipient in order to ensure that the gift registry is being provided to the correct gift recipients

In either instance, the secure information of the gift recipient is made less secure by sharing with a large group of people in order to receive gift credits through the gift registry. The recipient's full name or other personal information is widely shared. In addition, some people may desire to give gifts confidentially but be limited in their ability to do so based on having to get the personal information needed to transfer the gift.

Therefore, a need exists to develop systems, methods, computer program products and the like that allows for gift-providing customers to gift credit to a registry, such that gifts can be given for specific purposes without the requirement for sharing of personal confidential information. In effect, the desired invention eliminates the need for the gift-giver to know the secure information of the user but still be able to give gifts for specific purposes and, moreover, allows the gift-recipient to redeem the credit for items or services on the registry.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later

Embodiments of the present invention describe an innovative virtual registration system that provides for credit to be attached to an account by means of an alias. By attaching the credit to the recipient's virtual registry by means of an alias, the recipient is able to receive gifts for specific events without providing secure information, such as financial accounts, locations, or full names. As such, the present system insures that the user's secure information will be kept secure while still allowing the user to establish a registry for a personal event.

Embodiments of the present invention do not require gift recipients to share confidential account information with gift providers in order for the gift providers to bestow gift credit upon the gift recipients. In fact, through the use of the aliases, which serve to tie an identifier, such as a gift recipient's telephone number, email address or the like to a gift recipient's payment account/vehicle, embodiments of the invention do not require that the gift provider know any information about the financial accounts of the intended gift recipient.

A method for providing a virtual registry defines first embodiments of the invention. The method includes receiving gift credit instructions that include a gift credit type, gift credit amount and an alias associated with a registry. The method further includes determining that the alias is registered with a registry account associated with the gift recipient; and attaching the gift credit amount to the registry account based on determination that the alias is registered with the registry account. In further specific embodiments the method includes automatically applying the gift credit amount to a purchase made for an item on the registry based on the purchase being associated with the gift card type.

A system for providing virtual credit defines second embodiments of the invention. The system includes a computer apparatus including a processor and a memory. The system additionally includes a virtual registry module stored in the memory, executable by the processor and configured to receive gift credit instructions that include gift credit type, gift credit amount and alias associated with a registry. The system further includes a registry account determination module stored in the memory, executable by the processor and configured to determine that the alias is registered with a registry account associated with the gift recipient. In addition, the system includes a gift credit attachment module stored in the memory, executable by the processor and configured to attach the gift credit amount to the registry account based on determination that the alias is registered with the registry account. In additional embodiments of the system, upon attachment, the gift credit amount is configured to be automatically applied to a purchase made for an item on the registry based on the purchase being associated with the gift card type.

A computer program product for virtual registries defines third embodiments of the invention. The computer program product includes a non-transitory computer-readable medium having computer-executable instructions. The instructions provide for receiving gift credit instructions that include a gift credit type, gift credit amount and an alias associated with a registry. Additionally, the instructions provide for determining that the alias is registered with a registry account associated with the gift recipient. In addition the instructions provide for attaching the gift credit amount to the registry account based on determination that the alias is registered with the registry account. In additional embodiments of the computer program product the instructions provide for automatically applying the gift credit amount to a purchase made for an item on the registry based on the purchase being associated with the gift card type.

Thus, present embodiments of the invention, which are discussed in greater detail below, provide for systems, methods and computer program products for establishing virtual registries. The gift credit is automatically attached to a virtual registry of the gift recipient upon issuance of the gift credit. As such, the gift recipient is able to receive gifts from multiple individuals, including individuals with whom the gift recipient does not desire to share secure information. Additionally, through the use of aliases, which serve to tie an identifier, such as a gift recipient's telephone number, email address or the like, to a gift recipient's payment account/vehicle, embodiments of the invention simplify the process of electronic gift credit giving, in that the gift provider does not need to have knowledge of any information about the financial accounts of the intended gift recipient.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a block diagram of an apparatus configured to provide a virtual registry, in accordance with embodiments of the present invention;

FIG. 2 is a schematic diagram of a system configured for providing a virtual registry, in accordance with embodiments of the present invention;

FIG. 3 is a flow diagram of a method for providing a virtual registry, in accordance with an embodiment of the present invention;

FIG. 4 is a flow diagram of a detailed method for providing virtual registry credit, in accordance with embodiments of the present invention;

FIG. 5 is a block diagram of a virtual registry portal configured to provide gift providers options for searching and purchasing gift from a registry, in accordance with embodiments of the present invention;

FIG. 6 is a block diagram of a virtual registry portal configured to provide for gift provider entry of gift credit instructions, in accordance with embodiments of the present invention;

FIG. 7 is a combination flowchart and block diagram of a system and method for making P2P payments in accordance with example embodiment of the invention; and

FIG. 8 is a block diagram illustrating the various ways through which a customer may make P2P payments in accordance with various embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. In specific embodiments of the invention, use of the term “bank,” is limited to a financial entity in which account-bearing customers conduct financial transactions, such as account deposits, withdrawals, transfers and the like.

Embodiments of the present invention describe an innovative virtual registry system that provides for gift credit to be automatically attached to a registry created by a user for a specific event using an alias. By attaching the gift credit amount to the recipient's registry using the alias, a gift provider is able to provide a gift credit to the registry without requiring secure information from the gift recipient. As such, the present system ensures that a gift recipient's sensitive or secure information remains confidential while also providing a means for the gift recipient to receive contributions to a registry.

The present invention does not require gift recipients to share confidential account information with gift providers in order for the gift providers to bestow gift credit upon the gift recipients. In fact, through the use of aliases, which serve to tie an identifier, such as a gift recipient's telephone number, email address or the like to a gift recipient's gift registry, embodiments of the invention do not require that the gift provider know any information about the financial accounts of the intended gift recipient.

As used herein, registry may mean any type of gift registry. For example, the virtual registry may be a wedding registry, a registry for a baby shower, a registry for the purchase of a new home, etc. As should be understood, the system described herein enables a user to establish a registry for any event or purpose desired by the user, and include in the registry both items (e.g., glassware), services (e.g., house painting service after the purchase of a new home), or for an undesignated purpose (e.g., charitable giving). The registry may be created by an individual, a business, or a non-profit organization. The registry may have a specific end date or may be active indefinitely or until a specified goal is reached.

In some embodiments, the registry is associated with an individual's life event, such as a wedding, purchase of a home, birth, adoption, attending college, etc. In an embodiment, the registry is associated with a specific registry account. In some embodiments, the registry account is a standard checking and/or savings account held at a financial institution. In other embodiments, however, the registry account is specific to the life event. For example, the registry for the birth of a new baby may include a registry account associated with a college savings plan (e.g., a 529 educational plan). Life events such as a person's first job may include a registry account associated with an Individual Retirement Account (IRA) or 401K. In some embodiments, the registry is associated with a business. For example, the starting of a new business may include a registry directed to crowdfunding the business. Specific needs of the business may be specified in the registry or general funding may be provided for start-up expenses. In another example, a non-profit organization may use the system to encourage charitable giving. For example, a non-profit organization may create a registry for individuals requesting support, e.g., during a natural disaster or health issue. In this example, the registry may provide documentation that the gift was a deductible charitable donation for tax purposes. In an embodiment, the virtual registry provides a system whereby individuals are able to give monetary gifts for a specific purpose, without needing to know the recipients confidential account information.

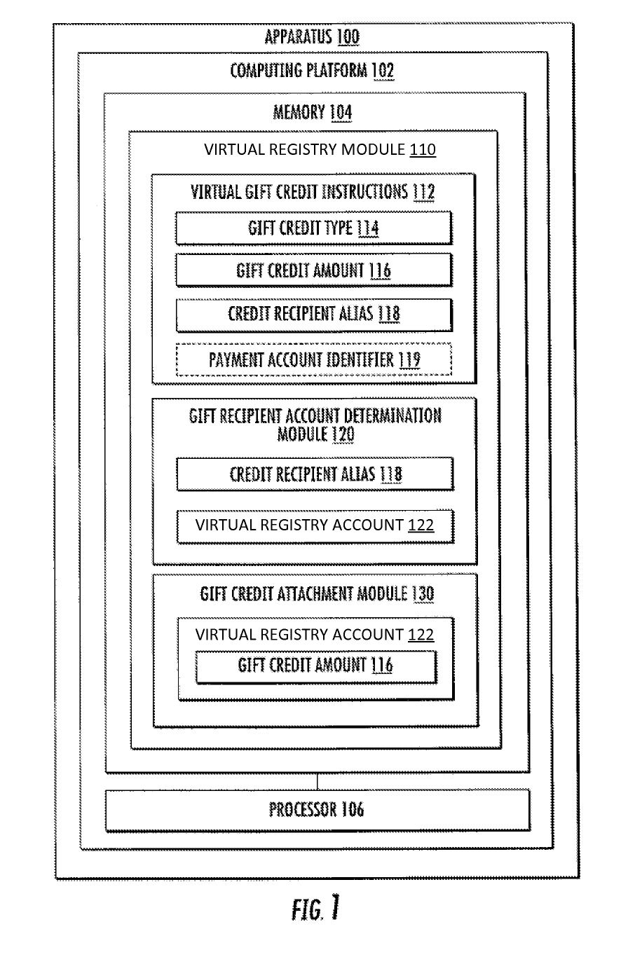

Referring to FIG. 1 a block diagram is depicted of an apparatus 100 configured to provide a virtual registry, in accordance with embodiments of the invention. The apparatus 100 includes a computing platform 102 having a memory 104 and at least one processor 106 in communication with the memory. The apparatus 100 may include any type and/or combination of one or more computing devices, such as servers, personal computers, or the like. The computing platform 102 is operable to receive and execute modules, routines and applications, such as virtual registry module 110, gift recipient determination module 120, gift credit attachment module 130 and the like. Memory 104 may comprise volatile and nonvolatile memory such as read-only and/or random-access memory (RAM and ROM), EPROM, EEPROM, flash cards, or any memory common to computing platforms. Further, memory 104 may include one or more flash memory cells, or may be any secondary or tertiary storage device, such as magnetic media, optical media, tape, or soft or hard disk.

Further, computing platform 102 also includes processor 106, which may be an application-specific integrated circuit (“ASIC”), or other chipset, processor, logic circuit, or other data processing device. Processor 106 or other processor such as ASIC may execute an application programming interface (“API”) layer (not shown in FIG. 1) that interfaces with any resident programs, such as virtual registry module 110, gift recipient determination module 120, gift credit attachment module 130 or the like, stored in the memory 108 of apparatus 102. Processor 106 may include various processing subsystems (not shown in FIG. 1) embodied in hardware, firmware, software, and combinations thereof, that enable the functionality of apparatus 100 and the operability of the apparatus on a network. For example, processing subsystems allow for initiating and maintaining communications, and exchanging data, with other networked devices. It should be noted that any of the modules, sub-modules, and routines shown and described as being stored in memory 104 may alternatively be embodied in processing subsystems.

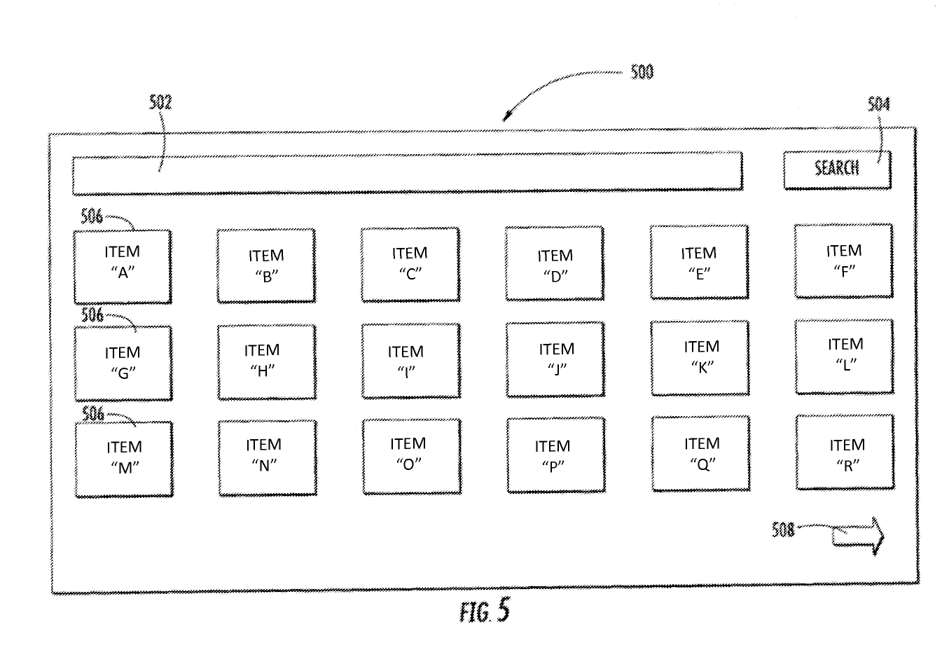

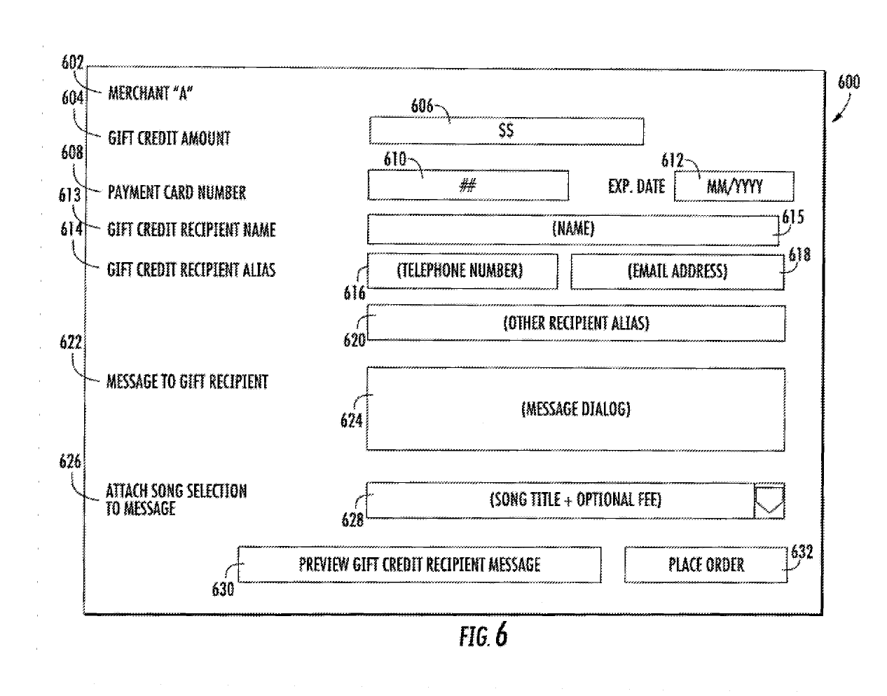

The memory 104 of apparatus 100 stores virtual registry module 110 that is configured to receive virtual gift credit instructions 112 from a gift provider or someone acting on behalf of the gift provider. In specific embodiments, as discussed in detail below in relation to FIGS. 5 and 6 the virtual registry module 110 provides for an Internet-based online registry portal and/or a mobile application, which gift credit providers/customers can access to purchase virtual gift credit for a gift recipient's registry. The virtual gift credit instructions 112 include, at a minimum, the gift credit type 114, the gift credit amount 116, and an alias 118 associated with a registry gift recipient alias. In most embodiments, the gift credit instructions 112 may also include a gift credit payment account identifier 119.

The gift credit type 114, which may be chosen by the gift provider/customer, defines the specificity of the use of the credit. For example, the module 110 may be configured to allow for gift credit types 114 that are specific to a designated item, such as an item on a registry. In other embodiments, the module 110 may be configured to allow for gift credit types 114 defined by a type of designated merchants, such as all items at a specific merchants listed on the registry. In still further embodiments, the module 110 may be configured to all for gift credit types for specific purposes, such as honeymoon or new home improvement and allow purchases within specific categories, specific locations, or for specific time windows (e.g., the time period where the gift recipient will be on the honeymoon). While in other embodiments of the invention, the module 110 may be configured to allow for generic gift credit, such as general credit applicable to any purpose designated by the event registry. In specific embodiments the module 110 may be configured such that the gift credit provider may tailor the gift credit instructions 112 such that that gift credit type 114 is gift provider-specific. For example, the gift provider may designate that the credit only apply to specific types of products (e.g., food), specific merchants, or the like and/or exclude specific types of products (e.g., alcohol, tobacco), specific merchants or the like. In addition, the module 110 may provide for the gift credit provider to tailor gift credit instructions 112 such that the gift credit type 114 is limited to use in a specific geographic region, limited to use during a designated time of the day, week, month or year or the like.

The gift credit amount 116 is typically at the discretion of the gift provider/customer. However, in certain embodiments the module may be configured and/or the merchants or gift recipient may designate a minimum and/or maximum gift credit amount.

The gift credit payment account identifier 119 may be a credit card number or debit card number of the credit provider or the like. In instances in which the virtual gift credit is pre-paid or paid means other than a payment account, e.g., a cash payment, the need for receiving the payment account identifier 119 may be obviated.

The credit recipient alias 118 is instrumental to the present invention, in that it allows for the gift credit provider/customer to provide the alias in lieu of providing gift recipient financial account information (i.e., account number, routing number and the like.) In present embodiments of the invention, the alias is typically an event name, telephone number, or email address of the registry owner. Since, the event name, telephone number, or email address of the gift credit recipient is either readily remembered by the gift provider or easily accessible to the gift provider (e.g., stored on or accessible to the gift provider's mobile communication device). In addition, in the event that the gift recipient has not registered an alias or has not registered the alias provided by the gift provider, the telephone number and/or email address provide for a means of communicating with the gift recipient to notify the gift recipient of the need to register an alias. However, in other embodiments, the gift credit recipient may designate other aliases besides or in addition to telephone numbers and/or email addresses, such as but not limited to, event dates, birthdates, usernames, passcodes, or the like. Advantageously, the alias may be shared easily with other individuals through personal communication, through digital media (e.g., social networking sites), or through print media. The alias, such as a short phrase, may be directed to the specific event or purpose of the registry. Placing the alias in an Internet-accessible medium, such as a social networking site, allows gift providers to the select the alias and provide the gift without having to know the specific account information of the recipient, or in fact any information about the recipient other than the alias.

The memory 104 of apparatus 100 additionally includes gift recipient account determination module 120 configured to determine that the credit recipient alias 118 included in the gift credit instructions 112 is registered with a virtual registry account 122 of the credit recipient. As such, the module 120 will communicate with an alias data repository to determine the registry of the gift recipient to which the alias is registered. In the event that a determination is made that the credit recipient has not registered the alias with a corresponding registry, a notification may be sent to the credit recipient asking them to access their financial institution (e.g., online access, mobile banking application or the like) for the purpose of receiving the gift credit (i.e., attaching the gift credit to a registry and/or registering the alias to a registry). The notification can be sent to the gift recipient by a system-configured or gift recipient-configured means, such as but not limited to, one or more of a text/SMS message, a voice mail, an email, social network site posting and/or the like. In the event, that the gift recipient ignores the notification or the gift recipient is otherwise unreachable (i.e., the alias provided by the gift provider does not identify a communication means) and, therefore, does not access their financial institution to attach the gift credit to a registry, after a predetermined period of time, a notification may be sent to the gift provider/customer cancelling the gift credit and returning the payment amount to the gift provider, e.g., crediting the payment account used by gift provider when purchasing the gift credit.

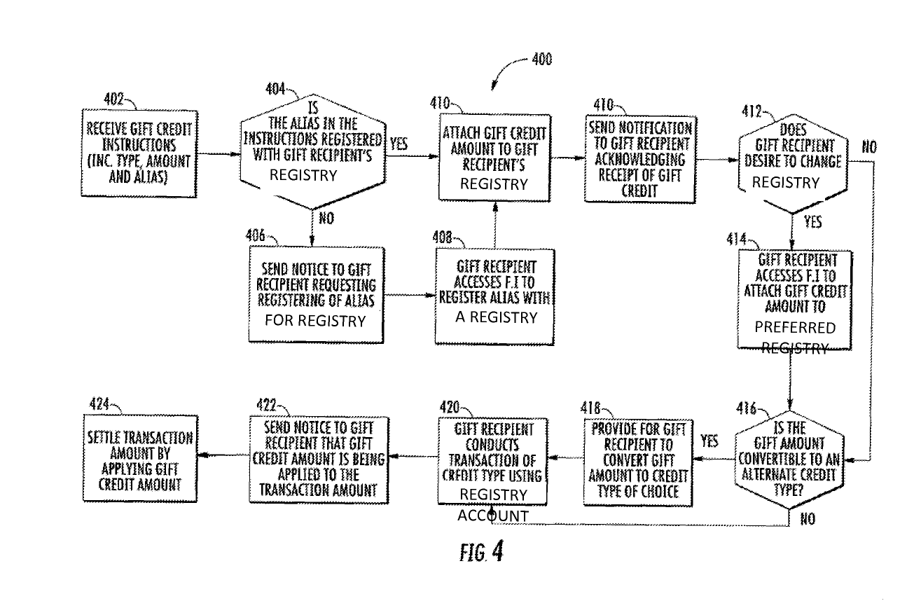

Additionally, the memory 104 of apparatus 100 includes gift credit attachment module 130 which is configured to attach the gift credit amount 116 to the virtual registry account 122 determined to be registered with the alias provided by the gift provider or as registered by the gift recipient upon notification of non-registration. The virtual registry account 122 may be a credit account, a debit account, a prepaid credit account, a line of credit account, a mortgage account, a loan account, checking/DDA account or the like, associated with a registry. Once the gift credit amount has been attached to the registry account, meaning a credit in the amount of the gift credit is applied to the registry account, the gift recipient may be notified, typically through text/SMS, email or the like, that they have received a gift credit from the gift provider. The notification may include the gift credit type, the gift credit amount, the registry to which the credit is attached and, optionally, a personalized message from the gift provider. In specific embodiments of the invention, as discussed in detail in relation to FIG. 4, the apparatus/system may be further configured to allow the gift recipient to change the registry to which the gift amount is attached and/or convert the credit type (e.g., convert the use of the credit from the designated item on the registry to another item, convert the use of the credit from a designated merchant to general use credit or convert the credit to cash, etc.).

As previously noted, once the gift credit has been attached to the payment account, any subsequent purchase of an item from the registry will be debited from the registry account. In this regard, the gift recipient does not need to take an overt action to apply the credit to the purchase of the item from the registry nor does the gift recipient need to be aware that the gift credit exists on the registry. For example, if the gift recipient makes a $100.00 purchase of an item on a registry designated for the gift credit and has an attached $50.00 gift credit, the purchase transaction will be for the $100.00 amount and the settlement of the transaction will apply the $50.00 gift credit to the transaction amount (i.e., the gift recipient will only owe the remaining $50.00 to complete settlement of the transaction). As a means of notifying the gift recipient that the gift credit is being applied, a notification stating such may be sent to the gift recipient in close proximity to the completion of the transaction, typically via text/SMS, email or the like.

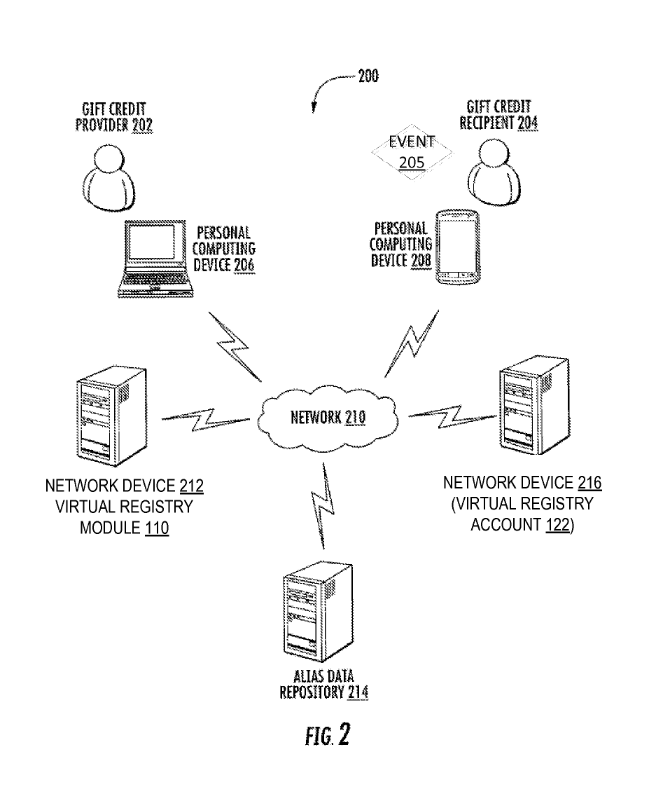

FIG. 2 provides a block diagram illustrating the architecture and environment of a virtual registry system 200, in accordance with an embodiment of the invention. As illustrated in FIG. 2, the virtual registry system 200 includes a gift credit provider 202 and a gift credit recipient 204, in which the gift credit provider 202 desires to send virtual gift credit to the gift credit recipient 204 for a registry. The gift credit provider 202 and/or the gift credit recipient may be an individual person, a group of persons, a business entity (e.g., a merchant) or any other entity capable of sending or receiving gift credit.

The virtual registry system 200 also includes personal computing devices 206 and 208, which are respectively associated with gift credit provider 202 and gift credit recipient 204. Each personal computing device 206 and 208 may be any device that employs a processor and memory, is configured to perform computing functions, and can communicate upstream and downstream via wireless and/or wired communication with communication network 210. As such, personal computing devices 206 and 208 may be personal computers (PCs), portable/laptop computers, mobile communication devices (e.g., smart phones, personal digital assistant (PDA), a mobile Internet-accessing device or the like) or the like. The communication network 210 may include a local area network (LAN), a wide area network (WAN), and/or a global area network (GAN). The network 210 may provide for wireline, wireless, or a combination of wireline and wireless communication between devices in the network. In one embodiment, the network 210 includes the Internet.

Personal computing device 208 is configured to communicate with network device 212, which may be a server or the like and is configured to provide access to virtual registry module 110. For example, in those embodiments in which the virtual registry module is an Internet-accessible gift credit portal, the gift credit provider 202 can access the portal via their corresponding personal computing device 206. In alternate embodiments, the virtual registry module 110 may be a downloadable application executable on the gift credit provider's personal computing device 206, such as a smart phone or the like. In other alternate embodiments, in which the virtual registry module is accessible via an online banking site or some other entities web site, the gift credit provider 202 may be required to log-on to the website prior to accessing the virtual registry module 110. The virtual registry module 110 is configured to allow the gift credit provider 202 to enter gift credit instructions to initiate the gift crediting process. As previously noted, the gift credit instructions include, at a minimum, the gift credit type 114, the gift credit amount 116, and the alias 118 associated with the event 205 designated by the gift credit recipient 204 and in some embodiments, a payment account identifier 119.

Once the gift credit provider 202 has properly submitted the required gift credit instructions, the alias 118 is communicated, via network 210, to alias data repository 214 to verify/determine that the alias is associated with a virtual registry account 122 of the intended gift credit recipient. In some embodiments of the invention, the alias data repository 214 is configured to be controlled and managed by one or more third-party data providers (not shown in FIG. 2) over the network 210. In other embodiments, the alias data repository 214 is configured to be controlled and managed over the network 210 by the same entity that maintains the virtual registry system 200, such as a financial institution or the like. In still other embodiments, the alias data repository 214 may be configured as a component of an online banking system.

If the alias 118 is not verified as being associated with a virtual registry account 122 of the intended gift credit recipient 204, a communication is sent to the gift credit recipient 204 via the network 210 or some other network, such as a cellular network or the like, requesting that the gift credit recipient register the alias 118 with a virtual registry at their respective financial institution, if their respective financial institution participates in the payment/alias program, or, if their respective financial institution does not participate in the payment/alias program, opening an account and registering the alias with a participating financial institution.

If the alias 118 is registered with a virtual registry account 122 or once the gift credit recipient 204 registers the alias with a virtual registry account 122, the virtual registry module 110 communicates with network device 216 to attach the gift credit amount to the registry account 122 of the gift credit recipient 204. In this regard, network device 216 may be a financial institution server or the like in the control of the gift credit provider's financial institution. In specific embodiments, once the gift credit amount is attached, a notification is communicated to the gift credit recipient 204, via personal computing device 208, notifying the recipient of the gift credit attachment and, optional, any personalized note provided by the gift credit provider 202.

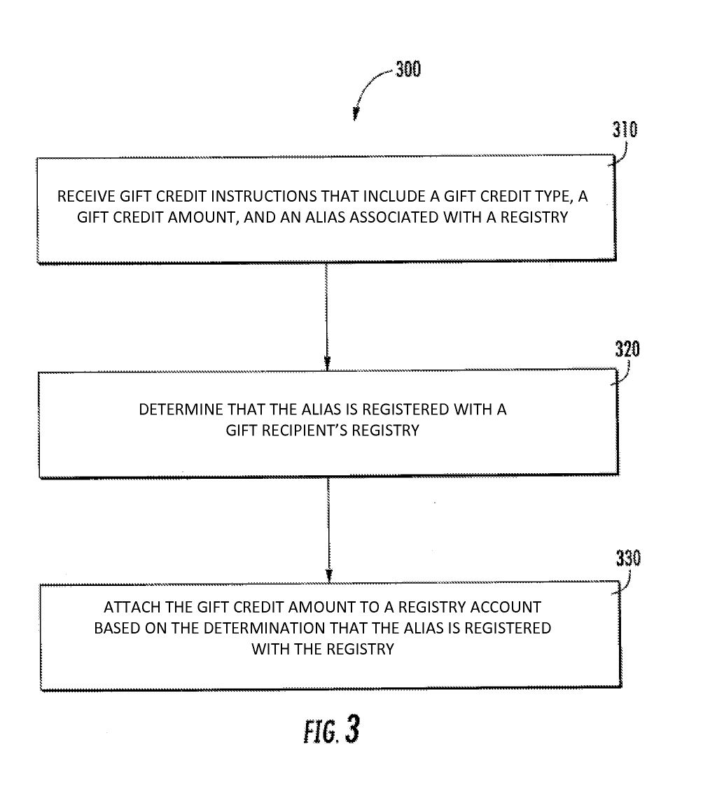

Referring to FIG. 3 a flow diagram is provided of a method 300 for providing a virtual registry, in accordance with embodiments of the present invention. At Event 310, gift credit instructions are received that include, at a minimum, a gift credit type, a gift credit amount, and an alias associated with a registry. In accordance with specific embodiments the gift credit instructions may be received through implementation of a gift credit web portal or the like, an example of which is shown and described in relation to FIGS. 5 and 6.

At Event 320, once the gift credit instructions have been received, a determination is made that the alias is registered with a registry account of the intended gift card recipient. Determination is accomplished by communicating the alias to an alias data repository or the like to verify that a match exists between the alias and a registry account. If the alias is not currently registered with the gift credit recipient, a notification may be sent to the intended gift credit recipient requesting that they register the alias with a registry account or otherwise provide for associating the gift credit with a registry account.

Once the alias is determined to be registered with a registry account of the intended gift credit recipient, at Event 330 the gift credit amount is attached to the registry account associated with the alias. Once the gift credit amount is attached to the registry account, a notification is communicated to the gift credit recipient notifying them of the gift credit and that the gift credit is ready to be redeemed for a purchase associated with the designated gift credit type (i.e., a purchase of an item on the registry designated by the gift provider or the like).

Referring to FIG. 4 a flow diagram is presented of a more detailed method 400 for providing a virtual registry, in accordance with embodiments of the present invention. The detailed method 400 of FIG. 4 provides for various alternate/optional embodiments of the present invention. At Event 402 gift credit instructions are received that include, at a minimum, a gift credit type, a gift credit amount, and an alias associated with a registry. In addition, the received gift credit instructions may include a payment account identifier, the name of the intended gift credit recipient, a personalized message stating the reason for the gift credit and the like.

At Decision 404, a determination is made as to whether the alias received in the gift credit instructions is registered with a registry of the intended recipient. If a determination is made that the alias is not currently registered with a registry account of the intended gift credit recipient, at Event 406, a notification is sent to the gift credit recipient requesting registration of the alias with a registry account of the gift credit recipient. At Event 408, the gift credit recipient accesses a financial institution, such as an online banking service or mobile banking application, to register the alias with a registry account. If the gift credit recipient's current financial institution does not participate in a peer-to-peer payment system, the gift credit recipient may be required to open an account and register the alias at a financial institution different from their current financial institution. While not shown in the method 400 of FIG. 4 it should be noted that if the intended gift credit recipient does not receive a notification requesting registration of the alias or receives the notification and either ignores the notification or chooses not to register the alias, upon lapse of a predetermined time period, the gift credit will be terminated and a notification sent to the gift credit provider that the gift credit amount is being credited back to the gift credit provider's payment account or otherwise refunded to the gift credit provider.

If a determination is made that the alias is registered with a registry account of the intended gift credit recipient (Event 404) or once the gift credit recipient accesses the financial institution and properly registers the alias with a registry account (Event 408), at Event 410, the gift credit amount is attached to the registry account designated by the gift credit recipient. Once the gift credit amount has been attached to the gift credit recipient's registry account, at Event 410 a notification is sent to the gift recipient acknowledging receipt of the gift credit and including any personalized message from the gift credit provider.

At Decision 412, if the gift credit system is configured for such, a determination is made as to whether the gift credit recipient desires to change the registry account to which the gift credit is attached. For example, the gift credit recipient may have preconfigured the system for attachment to a new home purchase registry account but may desire to switch the gift to a baby shower registry account. It should be noted that the decision to change the attached registry account may occur at any time in which the gift credit is outstanding, for example, shortly after receiving the gift credit or right before redemption of the gift credit. If the determination is made that the gift credit recipient desires to change the registry account, at Event 414, the gift credit recipient accesses the financial institution, such as via an online or mobile banking application, and attaches the gift credit amount to their preferred registry account.

At Decision 416, if the gift credit system is configured for such, a determination is made as to whether the gift credit recipient desires to convert the gift credit type to an alternate gift credit type. For example, the gift credit is designated by the gift credit provider for a specific item in a registry and the gift credit recipient desires to change the credit to any item in the registry, perhaps because someone has already purchased the selected item for the recipient. In other embodiments of the invention, the system may allow for the gift credit recipient to convert the gift credit to a cash payout. In specific embodiments, the system may allow for conversion of the gift credit type to another gift credit type or cash. In other specific embodiments in which the system provides for conversion, the gift credit provider may configure the gift credit such that the gift credit type is not subject to conversion or otherwise limited to type of conversion (i.e., the gift credit recipient must redeem the credit for the gift credit type designated by the gift credit provider or the gift credit recipient is limited to converting the gift credit to restaurant gift credit only). It should be noted that the decision to convert the gift credit type may occur at any time in which the gift credit is outstanding, for example, shortly after receiving the gift credit or right before redemption of the gift credit. As such, while Decision 416 is shown as occurring after the decision to change registry accounts it may in fact occur prior to or simultaneously with the decision to change registry accounts. If the gift credit recipient does desire to convert the gift credit amount, at Event 419, the gift credit recipient accesses the financial institution, such as via online or mobile banking applications, and converts the gift credit amount to their gift credit type of choice or to cash.

At Event 420, the gift credit recipient conducts a transaction of the type associated with the gift credit type and using the registry account to which the gift credit is attached. It should be noted that according to specific embodiments, the gift credit amount may be deducted from the transaction at the point of sale or, in most instances; the gift credit amount will subsequently be applied to settlement of the transaction. For example, the recipient may be purchasing an item on a registry or spending money during the predetermined period of time that the recipient is on a vacation. At Event 422, a notification, such as an a text/SMS, email or the like, is sent to the gift credit recipient shortly after the completion of the transaction that acknowledges that the outstanding gift credit amount is being applied to the transaction amount. At Event 424, the transaction is settled by applying the outstanding gift credit amount to the transaction amount.

Referring to FIG. 5 a block diagram is shown that depicts an example of a registry portal 500 for choosing various gift types, in accordance with an embodiment of the present invention. The portal, which may be accessible via the Internet or some other communication network, displays multiple tiles 506 which represent the gift types (e.g., specific items, specific categories, specific purposes, etc.) that may be purchased for virtual gift crediting in a registry. The gift credit provider may page through multiple pages of tiles 506 by activating the arrow key 508 or performing some other use input activity (e.g., scroll bar engagement) to page or scroll through the tiles 506. The tiles may be arranged in any order desired by the system provider and/or virtual gift card provider. For example, the tiles may be presented in alphabetical order, in order of most desired gift as indicated by the recipient or voted on by registry viewers or the like. In one embodiment, not shown in FIG. 5, keys or another input mechanism may be provided for the gift credit provider to choose the order of the tiles 506 from amongst various ordering selections.

The portal 500 additional is configured to include a search entry input 502 for entry of search criteria that defines the name or some other identifying feature of the gift that the giver desires to give. For example, the gift credit provider may enter a specific category, e.g., wine glasses, and, upon activating the search button 504, if the specific category is provided for in the registry, either the tile representing the item is displayed or the gift credit instruction entry page corresponding to that specific item is displayed. In other example, the gift credit provider may enter a term that defines a category of registry category, for example “honeymoon” and, upon activation of the search button 504, the system will return all of the items on a honeymoon list in registry. In yet another example, the gift credit provider may provide a physical address/region (e.g., city, state or country) or postal/zip code and, upon activation of the search button the system will return all of the gift credit types located in or proximate to the address/region or zip code.

The gift credit provider may select a registry gift by activating the corresponding tile 506 on portal 500 to display the registry gift instruction/order entry page 600 shown in FIG. 6. In alternate embodiments of the invention, the registry gift instruction/order entry page 600 for a specific registry may be accessible via a link provided on the corresponding merchant/retailer's web site, a quick response (QR) code in an advertisement for the merchant/retailer or the like. In an embodiment, gift recipients may have a quick code that can be placed in print, digital media, or online (e.g., in social networking sites, etc.) that allows gift providers to access the registry. The registry gift instruction/order entry page 600 includes an identifier 602 for the chosen gift credit type, i.e., the name of the registry or item in the registry or the like. In addition, the registry gift instruction/order entry page 600 includes gift credit amount identifier 604 and corresponding gift credit amount entry fields 606 configured for the gift credit provider to input the desired gift credit amount. As previously noted, the system may provide for minimum or maximum amounts for gift credits. Additionally, the amount may be entered in the gift provider's currency of choice and, if the gift credit type (i.e., specific item, specific purpose) is located in another country or the intended gift recipient is residing/located in another country the gift credit notification to the recipient may reflect the other country's currency. In addition, the registry gift amount may be configured to be exchanged to the currency of the recipient or the currency accepted by the registry gift retailer at the time the registry gift is purchased or at the time of the credit-applying transaction.

The also gift credit instruction/order entry page 600 also includes gift provider payment information identifier 608 and corresponding entry fields 610 and 612, configured for the gift credit provider to input their payment information, which in the illustrated embodiments include credit/debit card number entry field 610 and expiration date entry field 612.

In some embodiments, the registry gift instruction/order entry page 600 additionally includes gift credit recipient name identifier 613 and corresponding gift credit recipient name entry field 615 configured for the gift credit provider to enter in the name of the gift credit recipient. The name of the gift credit recipient may be used to verify that the alias provided by the gift credit provider matches an alias that is, in fact, associated with the named registry. Additionally, registry gift instruction/order entry page 600 additionally includes gift credit recipient alias identifier 614 and corresponding entry fields 616, 618 and 620 configured for the gift credit provider to enter one or more alias associated with the intended registry. In the illustrated embodiment of the FIG. 6, the alias entry fields include event date field 616, event name field 618 and event contact entry field 620 for entry of any other alias that the gift credit recipient may have registered in the system. Entry of multiple known aliases may insure that one of the aliases entered is an alias registered for the registry.

Optionally, registry gift instruction/order entry page 600 may include a “message to gift recipient” identifier 622 and corresponding dialog entry field 624 configured to allow the gift credit provider to personalize a message to the gift credit recipient that will either be included in the message notifying the recipient that the gift credit has been attached to their registry or notifying the recipient that the alias requires registration. Additionally, the gift credit instruction/order entry page 600 may include an “attach song selection to message” identifier 626 and a corresponding drop down menu 628 configured to provide the gift credit provider the option of attaching an audio/song file to the personalized message; such that the personalized message and attached audio/song file acts as multimedia greeting card.

Moreover, the registry gift instruction/order entry page 600 may include a “preview gift credit recipient message” button 630, which upon activation presents the personalized message along with the selected song/audio file, if so chosen. In addition, the registry gift instruction/order entry page 600 includes a place order button 632, which upon activation by the gift provider places the order for the gift and begins the process of verifying the alias and attaching the gift credit to the registry registered with the alias.

It should be noted that in alternate embodiments of the invention, the virtual registry system may be configured such that the gift credit provider is not limited to selecting a gift (i.e., specific item, category, registry, etc.) that is affiliated with the registry program. In such embodiments, the gift provider can choose any gift as long as the gift recipient accepts the gift for the registry to which the giver assigns it.

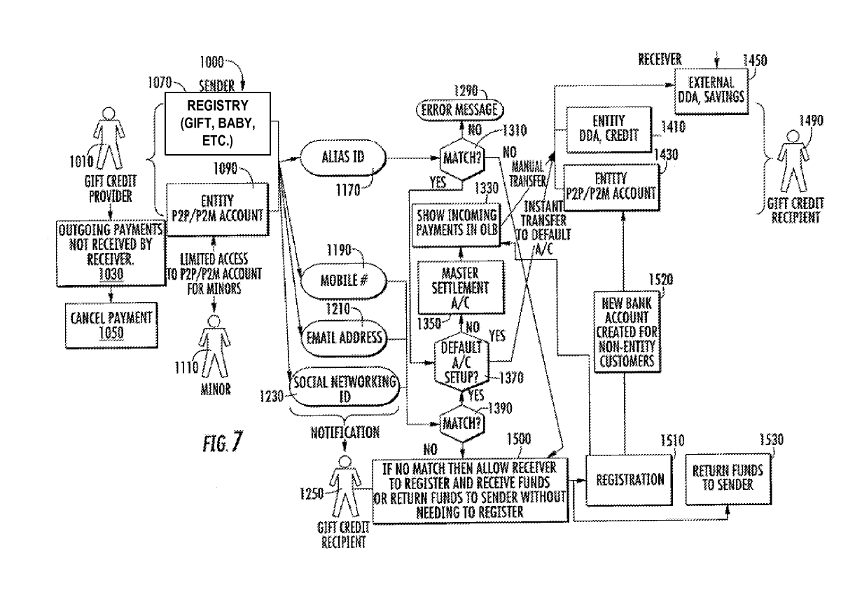

FIG. 7 is a combination block diagram and flowchart providing an overview of a general system and method 1000 for making peer-to-peer (P2P) payments, in accordance with one or more embodiments of the invention. A customer (i.e., gift recipient) 1490 with an eligible registry account 1070, e.g., gift registry, baby registry, wedding registry, charitable registry, etc., at a financial entity is able to register and make use of this service. During the registration process, the customer 1490 is able to set up an alias identifier (ID) 1170 (or simply an “alias”) that maps back to the customer's registry account. The alias 1170 may be any unique identifier other than the customer's financial institution account number. Typically, the alias 1170 is an identifier that friends, family, and/or other members of the public uniquely associate with the customer 1490 or registry account 1070. For example, the alias 1170 may be a mobile telephone number 1190, an email address 1210, a social networking ID 1230, an event name, and/or the like. The embodiments of the invention described herein in the other figures generally permit the customer 1490 to use either a mobile telephone number 1190 or an email address 1210 as the account alias, but it will be appreciated that, in view of this disclosure, other embodiments of the invention may allow use of other types of aliases.

The information provided by the customer 1490 during registration of an alias may be verified to confirm that the customer 1490 does have access to the mobile number 1190, email address 1210, social networking ID 1230, or other alias 1170 provided. For example, as described in greater detail below, the financial institution (or other entity that maintains a database of aliases and associates them with financial institution accounts) may send a communication to the customer 1490 using the alias and require the customer 1490 to confirm access to the alias by responding to the notice in some way. For example, if the alias registered by the customer 1490 is a mobile telephone number 1190, the financial institution may send a text message to the mobile telephone number 1190 with a code and then require that the customer 1490 enter the code into a mobile banking or online banking application to confirm that the mobile telephone number is associated with the customer 1490. Once the alias information is verified, the alias is linked to one or more of the customer's financial institution accounts in a data repository maintained by the financial institution or some other entity that provides an alias registry service to the financial institution.

The customer 1490 can also use embodiments of the invention to provide gift credit to other registries, such as secondary user 1250 having a gift registry, using an alias of the secondary user 1250. In some embodiments of the invention, the financial institution places limits (e.g., maximums and/or minimums) on how much money and/or gift credits can be sent or received over a specified period of time using P2P payment aliases, and such limits may be based on the sender/gift provider, the receiver/gift recipient, whether the receiver/gift recipient is a customer of the financial institution or a partner financial institution, account history, credit ratings, customer status, whether the customer has registered the alias, and/or any other relevant information. In some embodiments, the customer 1490 can also establish limits on purchasing and/or receiving P2P gift credits. For example, a customer 1490 may want to set a maximum of $1000 for P2P gift credit deposits in a registry where an alias is used for the recipient as opposed to an account number.

In some embodiments of the invention, the customer 1490 may also have an option of opening a new P2P (e.g., registry) account 1090 with the financial institution that the customer may use exclusively for making and/or receiving P2P payments, such as purchasing gift credits and/or receiving/attaching gift credits. This financial entity P2P account 1090 may be like any other account hosted at the financial entity and, as such, money may be moved instantly into this account 1090 through the regular online banking transfer process for moving money between a customer's accounts. P2P/gift credit account 1090 may be a type of DDA (demand deposit account) or credit account, however, that it may come with certain limitations, e.g., no checks, maximum balance limits, maximum number of daily transactions or the like, and may be opened by customers providing much less information as compared to a regular DDA account. The financial entity may, at a minimum, require customers to provide certain information, such as the event name, the user name, address, date of birth, and social security number, in order to comply with Anti-Money Laundering (AML) regulations. Customers 1490 of the financial entity may also have an option to set up P2P accounts 1090 (i.e., sub-accounts) for minors 1110, other dependents, or related entities. Customers 1490 are able to access these accounts just like any of their other accounts. In addition, customers 1490 are able to set up an online banking access ID for the minor 1110 that the minor 1110 may use to sign into online banking but have access only to the specific minor P2P account 1090 set up for them.

In accordance with embodiments of the invention, registry gifts may be made by providing an alias 1170. In general, as described in greater detail below, the gift provider 1010 initiates a registry gift by using an alias and communicating the alias 1170 and an associated payment amount to the financial institution. The financial institution then accesses an alias database, or other type of data repository, to determine if the entered alias 1170 has been registered by the alias holder/gift recipient and is, thereby, associated with a particular financial institution account. If the alias 1170 does have a match to a payment account of the registry gift recipient, then the attachment of the registry gift may be initiated to the gift recipient, as described in greater detail below. If there is no match, then either an error message 1290 is generated or, if possible, the alias 1170 may be used to contact the intended gift credit recipient 1490 and allow this person to register the alias 1170 and thereby associate the alias with an event and a financial institution account. At any time, if the registry gift is not attached to the recipient's registry account and/or gift credit notifications are not received (as represented by block 1030), the registry gift may be canceled (as represented by block 1050).

In some embodiments of the invention, an alias 1170 may be associated with multiple events of the alias holder. In some such embodiments, the alias holder may be able to establish a default account for registry gifts when registering the alias 1170 or afterwards. Consequently, if a gift credit recipient 1490 does have a default account for incoming registry gifts in 1370, then the funds may be attached instantly to that account(s). If the gift recipient 1490 has not set up a default account in 1370 but the gift credit recipient 1490 does have multiple events associated with the alias 1170, then the funds may be moved to a master payment/settlement account 1350 and the gift credit recipient 1490 may see the payment as an incoming payment within online banking 1330, mobile banking or the like. The gift credit recipient 1490 may then be able to use the online banking application to attach the credit amount instantly to any of the receiver's others events. In other embodiments, however, each alias 1170 is associated only with one event and, therefore, steps 1370 and 1350 are not needed and the payment is deposited directly into the one financial institution account associated with the alias 1170. In such instances, the registry gift recipient 1490 may be able to change the attached account after the registry gift has been attached to the preconfigured financial institution associated with the alias 1170.

As further illustrated in FIG. 7, the alias 1170 may be a mobile telephone number 1190 and, as such, a registry gift may be made by the gift credit provider 1010 providing a mobile phone number 1190 of the intended registry gift recipient 1490 along with an associated payment amount. If, at Decision 1390, there is no match, then a text message voice mail message or the like may be sent to the mobile number 1190 provided (as represented by block 1500). If the intended registry gift recipient 1490 is an existing financial institution customer (or, in some embodiments, if the gift credit recipient 1490 is a customer of a partner financial institution also participating in the P2P gift credit program), then that intended registry gift recipient may be allowed to sign into their online or mobile banking account, register the phone number as illustrated by block 1510 (thereby associating the phone number with a financial institution account for P2P registry gift receipt purposes), and then receive the registry gift similar to the process described above for the alias 1170. If the registry gift recipient 1490 is not a financial entity customer with an account eligible for receiving registry gift, then the registry gift recipient 1490 may be given the option to sign up (as represented by block 1520) for a financial institution account 1410 or 1430 at the financial institution or provide for the return of the registry gift to the registry gift provider (as represented by block 1530).

As further illustrated in FIG. 7, the alias 1170 may be an email address 1210 and, as such, registry gift purchase may be made by the registry gift provider 1010 providing an email address 1210 of the intended registry gift recipient 1490 along with an associated registry gift amount. This operation may perform exactly as described above for a mobile number 1190 except that the notification message (with the registration or account opening option if appropriate) is sent to the email address 1210 provided.

In some embodiments of the invention, virtual registry gift crediting may be made by providing a social networking ID 1230, such as a unique ID associated with the intended registry gift recipient 1490 on a particular social networking Internet site. In such a situation, the process operates in the same way as described above for mobile phone number 1190 and email address 1210 except the social networking platform may be used to notify the receiver based on the social networking ID 1230 provided.

In all cases described above, if the intended registry gift recipient 1490 is already a customer of the financial institution or a partner financial institution and has already registered the alias 1170 provided by the gift provider 1010, a text message, email, online banking notice, mobile banking notice, social network posting or other type of message may be sent to registry gift recipient 1490 based on the alias 1170 entered by the registry gift provider 1010 or irrespective of information entered by registry gift provider if there is other contact information found in the registry gift recipient's profile, the notification notifying the registry gift recipient 1490 of the registry gift. In some embodiments, the registry gift recipient 1490 may be allowed to decline the registry gift or re-route the registry gift to another recipient. In some embodiments of the invention, the registry gift provider 1010 is permitted to include a personalized note to the registry gift recipient 1490 along with the registry gift notice, such as a personalized note explaining to the recipient the reason or intent for the registry gift.

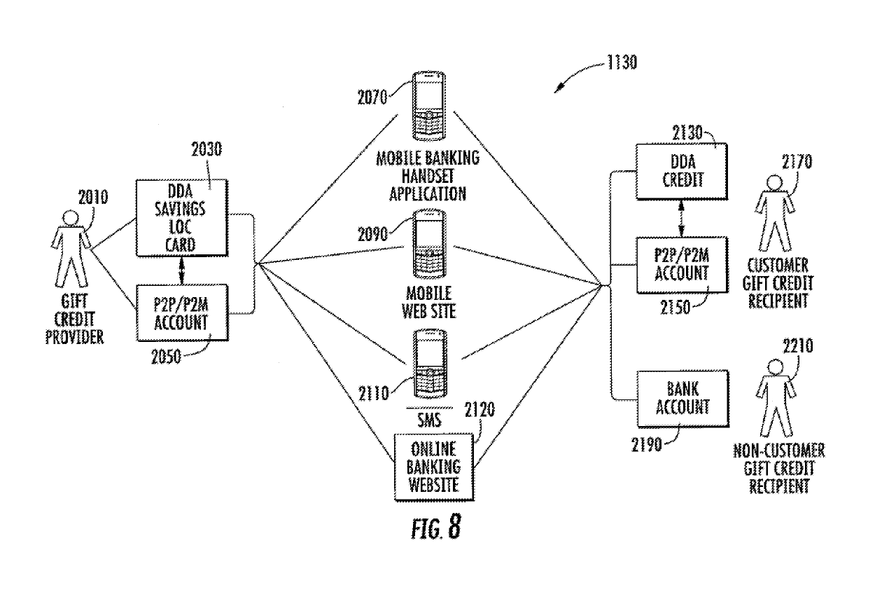

FIG. 8 is a block diagram illustrating the various ways through which a customer may make P2P registry gift purchases in accordance with various embodiments of the invention. As illustrated, in some embodiments of the invention, a customer/gift credit provider 2010 who may in some embodiments be signed up for the P2P payment service has the option to initiate P2P gift credit purchases from a DDA, savings, line of credit, and/or credit card account 2030 of the financial entity (and/or from a P2P-specific account 2050 held with the financial entity) through the financial entity's mobile banking website 2090 or a mobile banking handset application 2070 by providing any of the above-described alias information, e.g., event name, phone number, email address, social networking ID, and/or other alias, along with a gift credit amount and gift credit type. In some embodiments of the invention, customers can alternatively or additionally initiate gift credit purchase by sending a text message 2110 to the financial entity, the text message including the gift credit recipient's event name, phone number, email address, social networking ID, nickname, or other alias, the gift credit amount, the gift credit type and, in some instances the gift credit payment account. In some embodiments, customers can alternatively or additionally use the financial institution's online banking website 2120 to initiate purchase of a gift credit using an alias. Whether via a mobile banking handset application 2070, mobile website 2090, short message service 2110, or online banking website or standalone website 2120, a gift credit recipient 2170 associated with the financial entity may attach gift credit to the recipient's financial institution account (e.g., DDA, or credit account 2130 or P2P-specific account 2150). A gift credit recipient 2210 not associated with the financial entity 2210 may attach gift credit at the receiver's financial institution registry account 2190 at another partner financial institution if the registry account is registered and associated with the alias and/or the recipient 2210 may be prompted to register for the service and/or open a registry account with the financial institution in order to receive the gift credit from the gift credit provider 2010.

It should be appreciated that embodiments of the invention described above permit a gift credit provider to send gift credit to another entity even if the gift credit provider entity does not know any account information for the recipient entity and only knows an event name, mobile telephone number or email address associated with the registry. This can also result in better protection of personal account information. It should also be appreciated that some embodiments of the invention create a viral registration and/or account opening system that allows for customers of a financial institution to send gift credits to anyone outside the financial entity using an alias. In such embodiments, the non-customers are contacted using the alias and they are allowed to quickly open and/or register an account with the financial institution in order to attach the gift credit amounts sent from the gift credit provider to a registry.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing a virtual registry, the system comprising:
a computer apparatus including one or more processors and a memory;
an alias repository stored in the memory; and
a virtual registry module stored in the memory, executable by the processors and configured to receive gift credit instructions that include gift credit type, gift credit amount and an alias associated with a registry and including:
a gift recipient account determination module stored in the memory, executable by one of the processors and configured to access the alias repository to determine that the alias is registered with a registry account associated with a gift recipient, and
a gift credit attachment module stored in the memory, executable by one of the processors and configured to attach the gift credit amount to the registry account based on determination that the alias is registered with the registry account.

2. The system of claim 1, wherein the gift credit amount is automatically applied to a purchase made for an item on the registry.

3. The system of claim 1, wherein the alias is provided as a unique link configured to be shared by the gift recipient

4. The system of claim 1, wherein the virtual registry module further comprises a communication module stored in the memory, executable by one of the processors and configured to provide communication between the gift recipient and a gift giver.

5. The system of claim 1, wherein the registry account is a specialized account based on the registry.

6. The system of claim 5, wherein the specialized account is selected from the group consisting of a college savings plan, an Individual Retirement Account, and a Flexible Spending Account.

7. The system of claim 1, wherein the registry is associated with a life event of the gift recipient.

8. A computer program product for providing a virtual registry, the computer program product comprising a non-transitory computer-readable medium having computer-executable instructions to cause a computer to implement the steps of:
receiving gift credit instructions that include a gift credit type, gift credit amount and an alias associated with a registry;
determining that the alias is registered with a registry account associated with a gift recipient; and
attaching the gift credit amount to the registry account based on the determination that the alias is registered with the registry account.

9. The computer program product of claim 8, wherein the gift credit type specifies a specific item that the gift credit amount is usable to purchase.

10. The computer program product of claim 8, wherein the gift credit instructions further comprise a time period during which the gift credit amount must be used, wherein a remaining portion of the gift credit amount is returned to a provider of the gift credit amount at an end of the time period.

11. The computer program product of claim 8, wherein the steps further comprise providing communication between the gift recipient and the provider of the gift.

12. The computer program product of claim 8, wherein the alias is provided as a unique link configured to be shared by the gift recipient.

13. The computer program product of claim 8, wherein the registry is associated with a specialized account specific to a life event of the gift recipient.

14. The computer program product of claim 8, wherein the specialized account is selected from the group consisting of a college savings plan specific to the a new child, an Individual Retirement Account specific to a new job, and a Flexible Spending Account specific to a medical condition.

15. The computer program product of claim 8, further comprising tracking progress to a goal associated with the gift registry and alerting the gift recipient when the goal is reached.

16. The computer program product of claim 15, wherein the goal is selected from the group consisting of a minimum amount of funds in the registry account and a minimum number of items in the registry selected for purchase based on gift credit type.

17. A method for providing a virtual registry, the method comprising:
receiving, via a computing device, registry gift instructions that include a gift credit type, gift credit amount, and an alias associated with a registry;
determining, via a computing device processor, that the alias is registered with a registry account associated with the gift recipient; and
attaching, via a computing device processor, the gift credit amount to the registry account based on the determination that the alias is registered with the registry account.

18. The method of claim 17, further comprising automatically applying, via a computing device processor, the gift credit amount to a purchase of an item on the registry, wherein the item is associated with the gift card type.

19. The method of claim 17, further comprising communicating, via a computing device, a gift credit application notification to the gift recipient, wherein the gift credit application notification notifies the gift recipient that at least a portion of the gift credit amount is being applied to a purchase.

20. The method of claim 17, wherein receiving further comprises receiving, via the computing device, the gift credit instructions that include a gift credit payment account identifier associated with a gift provider.

21. The method of claim 17, wherein receiving further comprises receiving, via the computing device, the gift credit instructions that include a personalized message for the gift recipient.

22. The method of claim 17, further comprising communicating, via a computing device, a gift reception notification to a gift provider based on the gift credit amount being attached to the registry account, wherein the gift reception notification includes a personalized message.

23. The method of claim 17, further comprising communicating, via a computing device, an alias registration request to the gift recipient if the alias is determined to not be registered with a registry account associated with the gift recipient, wherein the alias registration request provides instructions for registering the alias with a registry account.

24. The method of claim 17, wherein receiving further comprises receiving, via the computing device, the gift credit instructions that include a time period during which the gift credit amount must be used, wherein a remaining portion of the gift credit amount is returned to a provider of the gift credit amount at an end of the time period.
